(19) United States
(12) Patent Application Publication
(10) Pub. No.: US 2025/0168734 A1
(43) Pub. Date: May 22, 2025

(54) MINIMIZATION OF DRIVE TEST OR SUCCESSFUL MOBILITY REPORTING IN NON-TERRESTRIAL NETWORKS

(71) Applicant: QUALCOMM Incorporated, San Diego, CA (US)

(72) Inventors: Shankar KRISHNAN, San Diego, CA (US); Rajeev KUMAR, San Diego, CA (US); Bharat SHRESTHA, San Diego, CA (US); Umesh PHUYAL, San Diego, CA (US)

(21) Appl. No.: 18/513,115

(22) Filed: Nov. 17, 2023

(51) Int. Cl. H04W 36/32; H04L 43/04; H04W 36/00; H04W 84/06

(52) U.S. Cl. CPC H04W 36/32; H04L 43/04; H04W 36/0072; H04W 84/06

(57) ABSTRACT

Various aspects of the present disclosure generally relate to wireless communication. In some aspects, a user equipment (UE) may perform a mobility operation in or to a non-terrestrial network (NTN). The UE may transmit a report indicating a success or failure of the mobility operation, wherein the report is associated with a timing difference of the mobility operation satisfying a threshold associated with at least one of the NTN or the mobility operation. Numerous other aspects are described.

### FIELD OF THE DISCLOSURE

Aspects of the present disclosure generally relate to wireless communication and specifically relate to techniques, apparatuses, and methods for minimization of drive test (MDT) or successful mobility reporting in non-terrestrial networks (NTNs).

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a non-transitory computer-readable medium storing a set of instructions for wireless communication includes one or more instructions that, when executed by one or more processors of a user equipment (UE), cause the UE to: perform a mobility operation within or to a non-terrestrial network (NTN); and transmit a report indicating a success or failure of the mobility operation if a timing difference of the mobility operation satisfies a threshold associated with at least one of the NTN or the mobility operation, or transmit the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

In some aspects, a non-transitory computer-readable medium storing a set of instructions for wireless communication includes one or more instructions that, when executed by one or more processors of a user equipment (UE), cause the UE to: collect, in association with an out-of-coverage (OOC) state for at least one of a terrestrial network (TN) or a non-terrestrial network (NTN), logged minimization of drive test (MDT) information; and transmit a logged MDT report indicating the OOC state and the logged MDT information.

In some aspects, a method of wireless communication performed by a user equipment (UE) includes performing a mobility operation within or to a non-terrestrial network (NTN); and transmitting, via the transceiver, a report indicating a success or failure of the mobility operation if a timing difference of the mobility operation satisfies a threshold associated with at least one of the NTN or the mobility operation, or transmitting, via the transceiver, the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

In some aspects, a method of wireless communication performed by a UE includes collecting, in association with an out-of-coverage (OOC) state for at least one of a terrestrial network (TN) or an NTN, logged minimization of drive test (MDT) information; and transmitting a logged MDT report indicating the OOC state and the logged MDT information.

In some aspects, an apparatus for wireless communication at a UE includes one or more memories; a transceiver; and one or more processors, coupled to the one or more memories and the transceiver, configured to cause the UE to: perform a mobility operation within or to a non-terrestrial network (NTN); and transmit, via the transceiver, a report indicating a success or failure of the mobility operation if a timing difference of the mobility operation satisfies a threshold associated with at least one of the NTN or the mobility operation, or transmit, via the transceiver, the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

In some aspects, an apparatus for wireless communication at a UE includes one or more memories; a transceiver; and one or more processors, coupled to the one or more memories and the transceiver, configured to cause the UE to: collect, in association with an OOC state for at least one of a TN or an NTN, logged MDT information; and transmit a logged MDT report indicating the OOC state and the logged MDT information.

In some aspects, an apparatus for wireless communication includes means for performing a mobility operation within or to a non-terrestrial network (NTN); and transmitting, via the transceiver, a report indicating a success or failure of the mobility operation if a timing difference of the mobility operation satisfies a threshold associated with at least one of the NTN or the mobility operation, or transmitting, via the transceiver, the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

In some aspects, an apparatus for wireless communication includes means for collecting, in association with an OOC state for at least one of a TN or an NTN, logged MDT information; and means for transmitting a logged MDT report indicating the OOC state and the logged MDT information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a regenerative satellite deployment and an example of a transparent satellite deployment in a non-terrestrial network.

FIG. 5 is a diagram illustrating an example of self-organizing network reporting in a non-terrestrial network (NTN), in accordance with the present disclosure.

FIG. 6 is a diagram illustrating an example of logged minimization of drive test reporting in an NTN, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A radio access technology (RAT) may support non-terrestrial networks (NTNs). For example, the 5G or 6G RAT may support NTN deployments. In an NTN, coverage may be provided by a satellite. For example, the satellite may act as a gateway to a core network or data network. As another example, the satellite may act as an intermediary between a terrestrial gateway and covered user equipments (UEs), thereby increasing the coverage area of the network relative to providing coverage directly from the terrestrial gateway. NTNs may provide coverage of large geographic areas, including areas that are difficult for terrestrial networks (TNs) to cover (such as remote areas, oceans, or areas without established telecommunications operators), but may be associated with challenges that are not typical of TNs. For example, NTNs may generally have larger propagation delays, larger timing adjustments (TAs), and larger Doppler spreads than TNs due to high speed of the satellites and increased spatial separation between the satellites and the covered UEs.

A RAT may support mobility operations between network nodes (e.g., gNBs, cells, beams) of the RAT. One example of a mobility operation is a handover, in which an active connection and UE context is transferred from a first network node (e.g., providing a source primary cell (PCell)) to a second network node. Another example of a mobility operation is a primary secondary cell (PSCell) change, in which a PSCell of a UE (such as a UE using dual connectivity with a main cell group and a secondary cell group) is transferred from a first network node to a second network node. Mobility operations are generally based on measurements of signal strength of target cells or network nodes, such as Layer 3 reference signal received power (RSRP) or reference signal received quality (RSRQ) measurements. For example, the UE may perform a mobility operation to a given cell only if a measurement of the given cell satisfies a threshold (indicating that the given cell is suitable as a target cell for the mobility operation).

A UE may perform various forms of reporting regarding performance of the network. For example, the UE may provide self-organizing network (SON) reporting, minimization of drive test (MDT) reporting, or a combination thereof. SON reporting and MDT reporting may generally involve reporting of observed conditions at the UE, which may assist a SON entity or network operator in optimizing the operation of the network. For example, SON/MDT reporting may provide information regarding the network that is difficult to obtain by observing data rates, mobility success or failure, or other parameters that are easily determined by a gNB.

In an NTN, a mobility operation such as a handover or a PSCell change (such as a PSCell addition) can fail (or can succeed while almost failing) even if a target cell meets event thresholds for Layer 3 measurements. For example, a mobility operation may fail or almost fail if a propagation difference between a serving cell and a target/candidate cell is large, if a timing adjustment drift is large, or if an adjusted synchronization signal block (SSB) measurement timing configuration (SMTC) is large. As mentioned above, it may be beneficial for an NTN, such as a SON entity of the NTN, to be aware of conditions leading to failure or near-failure of mobility operations. However, it may be difficult to obtain such information by observing a binary indicator such as success or failure of mobility operations. Furthermore, some forms of SON reporting may be triggered by conditions irrelevant to failure or near-failure of mobility operations in NTNs.

A UE can log MDT information for the purpose of later reporting the logged MDT information. This may be beneficial for logging occurrences where the UE is in an out-of-coverage (OOC) state. However, some deployments may define the OOC state with regard to only TNs, or without regard to whether the UE is covered by an NTN, a TN, or a combination thereof. For example, a UE may be considered OOC when not covered by a TN, irrespective of whether the UE is covered by an NTN. Thus, logged MDT reporting using an OOC state defined with regard to only TNs or without regard to whether the UE is covered by an NTN may provide insufficient information about coverage to facilitate optimization of the network, leading to failure to address coverage holes in NTNs and decreased throughput.

Aspects of the present disclosure generally relate to SON/MDT reporting. Some aspects more specifically relate to SON/MDT reporting in an NTN. In some aspects, a UE may transmit a report (e.g., a SON report) indicating a success or failure of a mobility operation (e.g., a PSCell change, a handover, a radio link failure (RLF)). For example, the report may indicate that a timing difference of the mobility operation satisfies a threshold. The timing difference may include, for example, a propagation delay difference, a timing adjustment drift, an offset of an SMTC, or any combination thereof. Additionally or alternatively, in some aspects, the UE may transmit the report in response to a trigger for transmitting the report being satisfied, such as the UE failing to synchronize to a new satellite, failing to select a beam for which a configuration was provided, or falling back to a random access channel (RACH)-based handover. In some aspects, the UE may collect and report logged MDT information in association with an OOC state for at least an NTN. For example, the OOC state may indicate whether the UE is in coverage of only the TN, only the NTN, both the TN and the NTN, or neither the TN nor the NTN. In some aspects, an event triggering collection or reporting of the logged MDT information may be associated with the OOC state.

Aspects of the present disclosure may be used to realize one or more of the following potential advantages. In some aspects, by reporting that the timing difference of the mobility operation satisfies a threshold, the UE enables optimization of the network in view of near-failures of mobility operations, thereby improving reliability of mobility in NTNs. In some aspects, by transmitting the report in response to a threshold and/or trigger being satisfied, the UE enables SON/MDT reporting in NTNs using triggers and/or thresholds that are appropriate for NTN reporting. In some aspects, by logging and reporting MDT information for at least the NTN, the UE provides additional information about coverage of the NTN, thereby enabling network optimization and reduction or elimination of coverage holes. In some aspects, by using an event associated with the OOC state to trigger collection or reporting of the logged MDT information, logged MDT reporting specific to NTNs is enabled, thereby further enabling network optimization.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

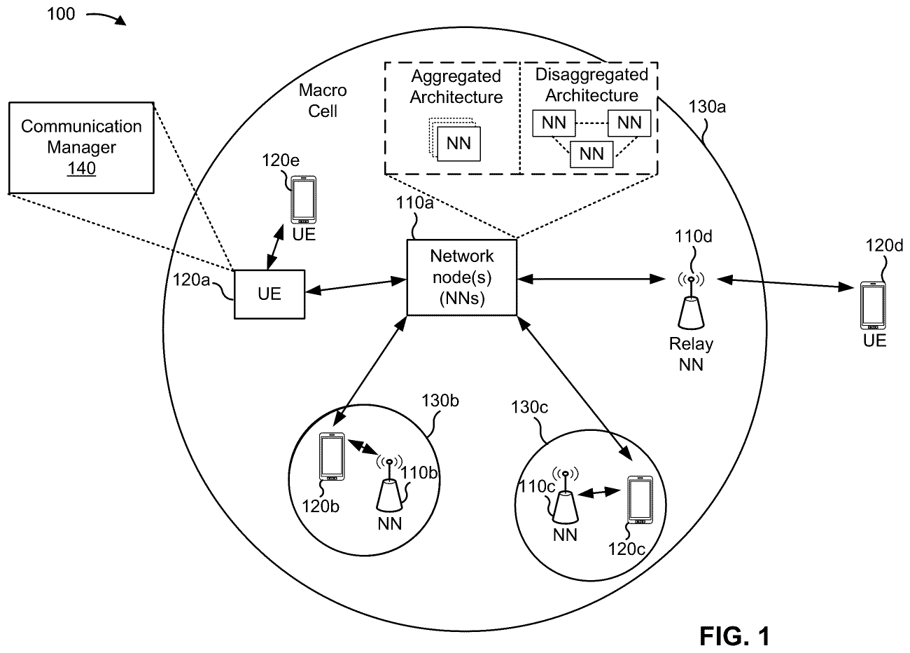

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHZ through 24.25 GHz), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the14irelesss communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As indicated above, a network node 110 may be a terrestrial network node 110 (for example, a terrestrial base station or entity of a disaggregated base station) or an NTN network node 110. For example, the wireless communication network 100 may include one or more NTN deployments including a non-terrestrial network node, an NTN network node 110, and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120, other NTN network nodes 110 in the one or more NTN deployments, other types of network nodes 110 (for example, stationary, terrestrial, and/or ground-based network nodes), relay stations, and/or one or more components and/or devices included in or coupled with a core network of the wireless communication network 100. For example, an NTN network node 110 may communicate with a UE 120 via a service link (for example, where the service link includes an access link). Additionally or alternatively, an NTN network node 110 may communicate with a gateway (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). An NTN deployment may be transparent (for example, where the NTN network node 110 operates in a similar manner as a repeater or relay and/or where an access link does not terminate at the NTN network node 110) or regenerative (for example, where the NTN network node 110 regenerates a signal and/or where an access link terminates at the NTN network node 110).

In some aspects, the UE 120 may include a communication manager 140. As described in more detail elsewhere herein, the communication manager 140 may perform a mobility operation within or to a non-terrestrial network (NTN); and transmit a report indicating a success or failure of the mobility operation if a timing difference of the mobility operation satisfies a threshold associated with at least one of the NTN or the mobility operation, or transmit the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation. In some aspects, the communication manager 140 may collect, in association with an OOC state for at least one of a TN or an NTN, logged MDT information; and transmit a logged MDT report indicating the OOC state and the logged MDT information. Additionally, or alternatively, the communication manager 140 may perform one or more other operations described herein.

As indicated above, FIG. 1 is provided as an example. Other examples may differ from what is described with regard to FIG. 1.

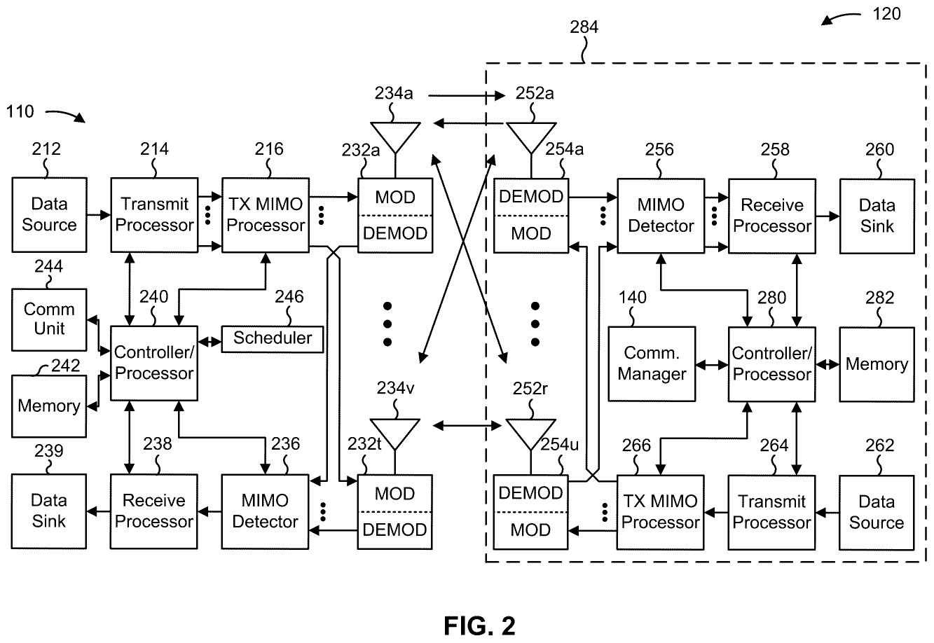

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, May perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

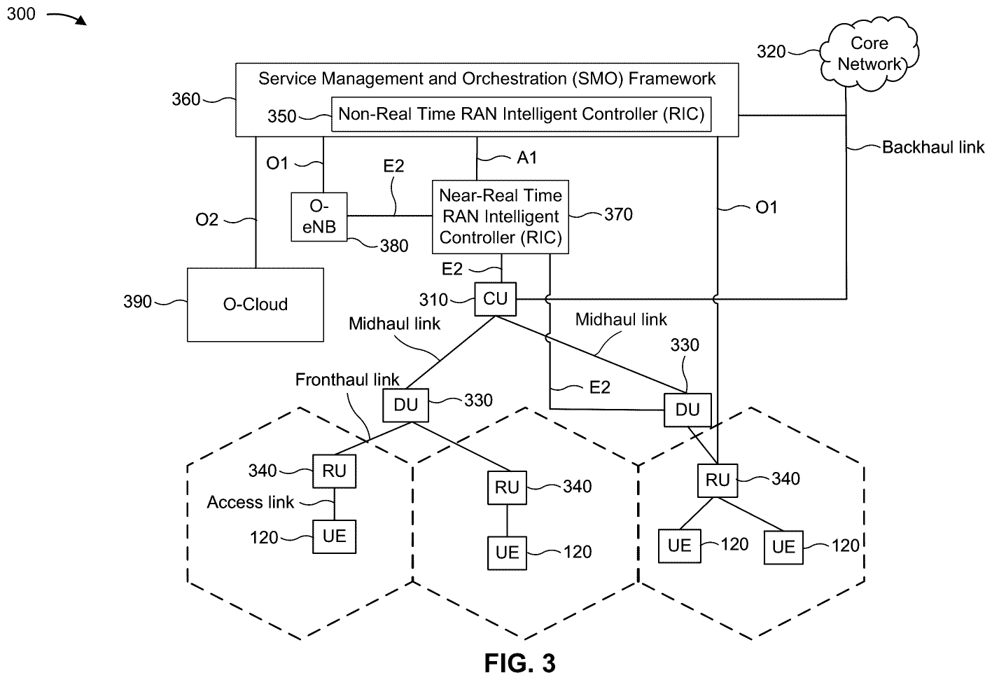

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 Interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

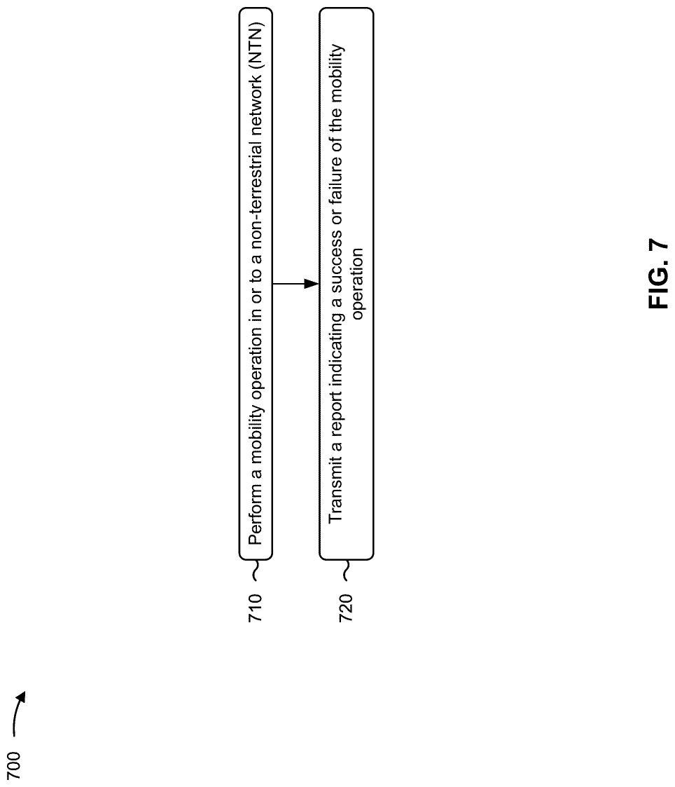

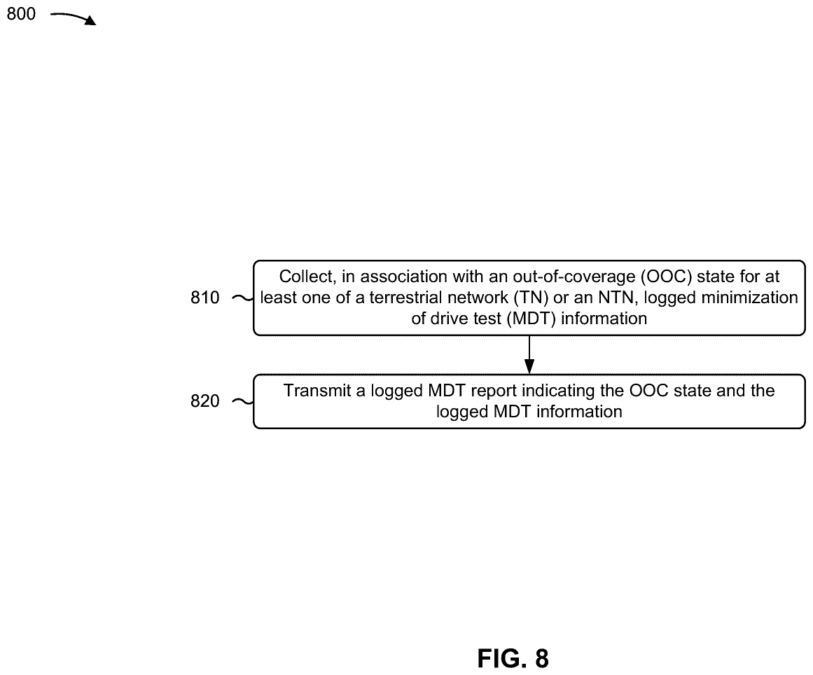

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with logged MDT/SON reporting, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the UE 120 includes means for performing (e.g., using antenna 252, modem 254, MIMO detector 256, receive processor 258, transmit processor 264, TX MIMO processor 266, controller/processor 280, or memory 282) a mobility operation in or to an NTN; and/or means for transmitting (e.g., using antenna 252, modem 254, MIMO detector 256, receive processor 258, transmit processor 264, TX MIMO processor 266, controller/processor 280, or memory 282) a report indicating a success or failure of the mobility operation, wherein the report is associated with a timing difference of the mobility operation satisfying a threshold associated with at least one of the NTN or the mobility operation. In some aspects, the UE 120 includes means for collecting (e.g., using antenna 252, modem 254, MIMO detector 256, receive processor 258, transmit processor 264, TX MIMO processor 266, controller/processor 280, or memory 282), in association with an OOC state for at least one of a TN or an NTN, logged MDT information; and/or means for transmitting (e.g., using antenna 252, modem 254, MIMO detector 256, receive processor 258, transmit processor 264, TX MIMO processor 266, controller/processor 280, or memory 282) a logged MDT report indicating the OOC state and the logged MDT information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

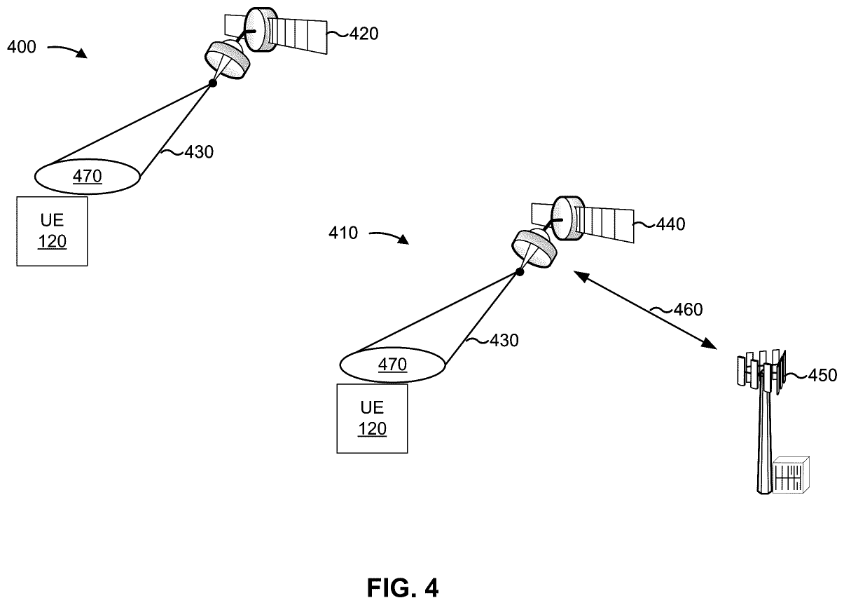

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120). An uplink of the service link 430 may be indicated by reference number 430-U (not shown in FIG. 4) and a downlink of the service link 430 may be indicated by reference number 430-D (not shown in FIG. 4). Similarly, an uplink of the feeder link 460 may be indicated by reference number 460-U (not shown in FIG. 4) and a downlink of the feeder link 460 may be indicated by reference number 460-D (not shown in FIG. 4).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

A coverage area of the satellite 420/440 is shown by reference number 470. For example, the coverage area may correspond to a cell. A UE 120 located outside of the coverage area may experience inadequate coverage, low throughput, radio link failure, or the like. A UE located outside the coverage area may be said to be out of coverage (OOC) with regard to the NTN. Thus, as the UE 120 moves out of the coverage area, or as the satellite 420/440's movement changes the coverage area, the UE 120 may perform mobility operations, such as handovers or PSCell changes/additions, to update the cell or satellite 420/440 to which the UE 120 is connected or camped.

As indicated above, FIG. 4 is provided as an example. Other examples may differ from what is described with regard to FIG. 4.

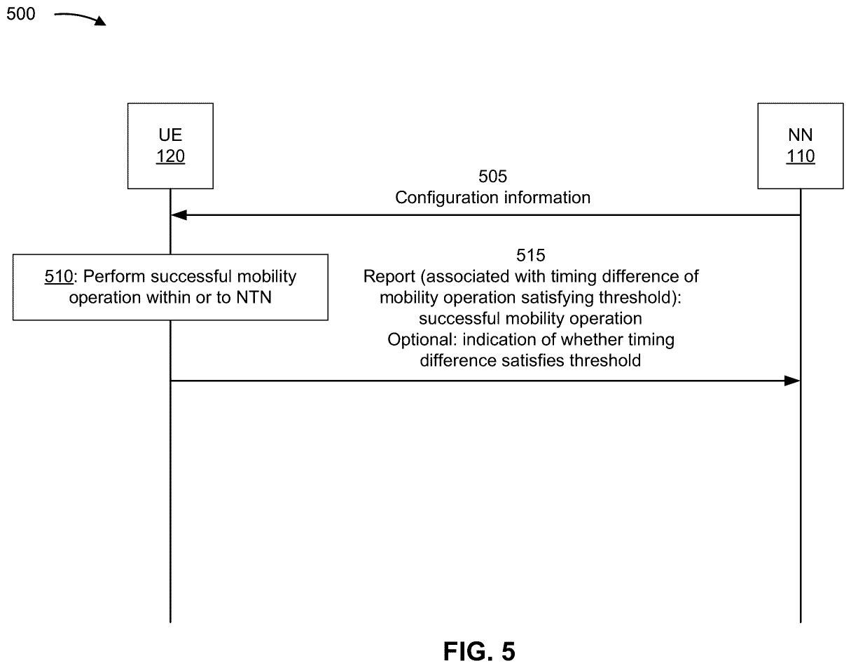

FIG. 5 is a diagram illustrating an example 500 of SON reporting in an NTN, in accordance with the present disclosure. Example 500 includes a UE 120 and a network node 110. The network node 110 may belong to an NTN. For example, the network node 110 may include a satellite 420/440 or a gateway 450. The UE 120 may communicate with the network node 110 via a service link (e.g., service link 430). In some aspects, the network node 110 may include or may communicate with a SON entity or another entity (e.g., core network entity) that can receive SON reporting and reconfigure a RAN.

As shown by reference number 505, in some aspects, the UE 120 may receive configuration information. For example, the configuration information may include system information, RRC signaling, medium access control signaling, downlink control information, or the like. In some aspects, the UE 120 may receive the configuration information from the network node 110. For example, the network node 110 may transmit the configuration information. In some aspects, the configuration information may indicate a threshold associated with the NTN. The threshold may include, for example, a threshold propagation delay difference, a threshold timing adjustment drift, a threshold offset of an SMTC, or a combination thereof. The threshold may be associated with the NTN in that the threshold is a threshold for a parameter related to NTN operation. For example, NTNs may be associated with propagation delay differences, timing adjustment drifts, and/or SMTC offsets greater than TNs, so a threshold defined according to one or more of these parameters may be considered to be associated with an NTN. The threshold may additionally or alternatively be associated with a mobility operation. For example, the threshold may be a threshold that triggers transmission of a report indicating success of the mobility operation.

A propagation delay is a length of time between a signal being transmitted and the signal being received. For example, the propagation delay may indicate a length of time between a signal being transmitted by a satellite 420/440 and received by the UE 120, or a length of time between a signal being transmitted by a gateway 450 and a corresponding signal being received by the UE 120 (e.g., via the satellite 420/440). The network node 110 may have a first propagation delay, and may be considered a source of a mobility operation. A target (e.g., target cell, candidate cell, network node 110) for a mobility operation may have a second propagation delay, which may differ from the first propagation delay. A propagation delay difference is a difference between the first propagation delay and a second propagation delay (e.g., one or more second propagation delays of each target for the mobility operation).

A timing adjustment (TA) (sometimes referred to as a timing advance) is a time offset that a UE 120 can apply to an uplink transmission so that the uplink transmission, when received by the network node 110, is synchronized to the network node 110. The network node 110 may have a first TA, and may be considered a source of a mobility operation. A target (e.g., target cell, candidate cell, network node 110) for a mobility operation may have a second TA, which may differ from the first TA. A TA drift is a difference between the first TA and a second TA (e.g., one or more second TAs of each target for the mobility operation).

An SMTC is a configuration that indicates a periodicity and timing of SSBs used by the UE 120 for cell quality measurements. An SMTC may be associated with an offset, which may indicate a time offset so that the timing of the SSBs (as received by the UE 120) is aligned with a local timing of the UE 120. The network node 110 may have a first SMTC, and may be considered a source of a mobility operation. A target (e.g., target cell, candidate cell, network node 110) for a mobility operation may have a second SMTC, which may differ from the first SMTC. An offset of an SMTC may indicate a difference between the first SMTC and a second SMTC (e.g., one or more second SMTCs of each target for the mobility operation).

In some aspects, the configuration information may indicate a trigger for transmitting the report. For example, the UE 120 may transmit a report (described at reference number 515) in response to the trigger being satisfied. In some aspects, the trigger may include the UE 120 failing to synchronize to a new satellite (e.g., a satellite corresponding to a target of the mobility operation). In some aspects, the trigger may include the UE 120 failing to select a beam for which a configuration was provided. For example, the configuration may include a configuration for communicating on the beam. As another example, the configuration may include a configuration for enabling reporting or transmitting the report on the beam. In some aspects, the trigger may include the UE falling back to a RACH-based handover when a target (cell, beam, carrier) is configured for RACH-less handover.

As shown by reference number 510, the UE 120 (and optionally the network node 110) may perform a mobility operation. For example, the UE 120 may perform a successful mobility operation from a first NTN node or cell to a second NTN node or cell. Thus, the mobility operation may be in an NTN. As another example, the UE 120 may perform a successful mobility operation from a TN node or cell to an NTN node or cell. Thus, the mobility operation may be to an NTN. More generally, the mobility operation may include transferring the UE 120 from a source (e.g., cell, beam, satellite, carrier) to a target (e.g., cell, beam, satellite, carrier). In some aspects, the mobility operation may include a handover. For example, the mobility operation may include a conditional handover or a dual active protocol stack handover. In some aspects, the mobility operation may include a PSCell change or a PSCell addition. The mobility operation may be associated with a timing difference of the mobility operation. In various aspects, the timing difference can include a difference between a timing (e.g., a reference signal timing, a propagation delay, a TA, a Doppler spread, an SMTC, etc.) associated with the source (e.g., cell, beam, satellite, carrier) and a timing (e.g., a reference signal timing, a propagation delay, a TA, a Doppler spread, an SMTC, etc.) associated with the target (e.g., cell, beam, satellite, carrier). In some aspects, the mobility operation may fail. In some aspects, the UE 120 may perform the operations of example 500 without performing a mobility operation. For example, the mobility operation may be omitted from example 500, and the report may relate to an RLF or the like.

As shown by reference number 515, the UE 120 may transmit a report. The report may indicate a success of the mobility operation. For example, the report may be a successful handover report or a successful PSCell change report. In some aspects, the report may be associated with a timing difference (described with regard to reference number 505) satisfying (e.g., being greater than, being less than, being greater than or equal to, being less than or equal to) a threshold. For example, the timing difference satisfying the threshold may be a trigger for generation and/or transmission of the report. As another example, the report may identify the timing difference or may identify whether or not the timing difference satisfies the threshold. For example, the UE 120 may transmit the report regardless of whether the timing difference satisfies the threshold or does not satisfy the threshold. In this example, the report may indicate whether the timing difference satisfies the threshold or does not satisfy the threshold (or may indicate the timing difference). In some aspects, the report may indicate failure of a mobility operation, such as an RLF.

As mentioned, in some aspects, the UE 120 may generate and/or transmit the report in accordance with a trigger. For example, the trigger may include a timing difference satisfying a threshold. As another example, the trigger may include one or more of the triggers described with regard to reference number 505. In some aspects, the trigger may include a combination of multiple of these triggers.

As indicated above, FIG. 5 is provided as an example. Other examples may differ from what is described with respect to FIG. 5.

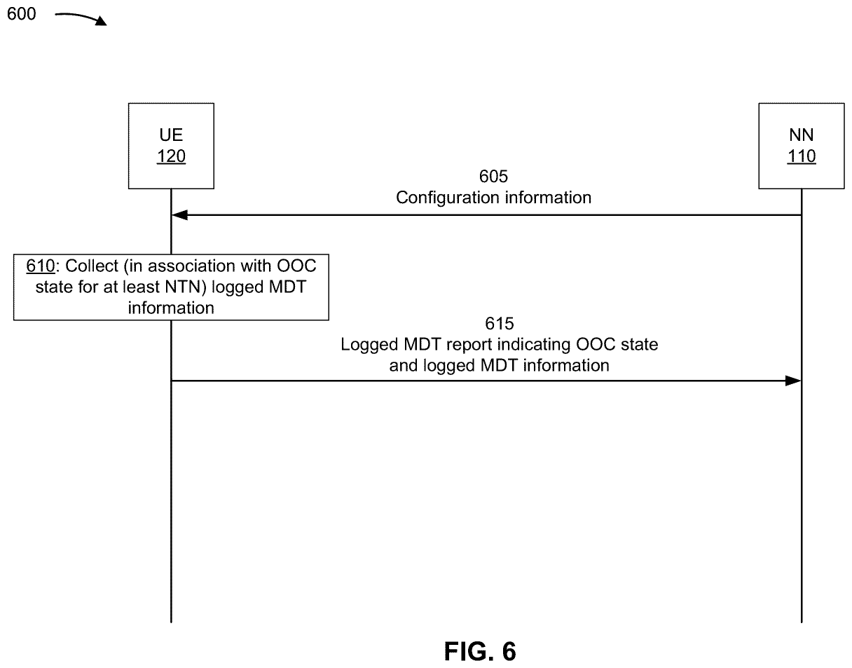

FIG. 6 is a diagram illustrating an example 600 of logged MDT reporting in an NTN, in accordance with the present disclosure. Example 600 includes a UE 120 and a network node 110. The network node 110 may include a satellite 420/440 or a gateway 450. The UE 120 may communicate with the network node 110 via a service link (e.g., service link 430). In some aspects, the network node 110 may include or may communicate with a SON entity or another entity (e.g., core network entity) that can receive SON reporting and reconfigure a RAN.

As shown by reference number 605, the UE 120 may receive configuration information. For example, the UE 120 may receive the configuration information from the network node 110 or from another network node. For example, the configuration information may include system information, RRC signaling, medium access control signaling, downlink control information, or the like. The configuration information can be provided via a single transmission or multiple transmissions. The configuration information may include one or more parameters relating to logged MDT reporting. For example, the configuration information may indicate one or more events to trigger storage of logged MDT information. As another example, the configuration information may include NTN payload assistance information (e.g., one or more ephemeris parameters and/or a start time of an upcoming NTN payload coverage, such as in a system information block type 32 (SIB32)). As another example, the configuration information may indicate a duration of an interval for which the UE 120 can store logged MDT information (e.g., longer than 61.44 seconds in some aspects). As another example, the configuration information may include TN cell coverage information, which may include a list of areas and associated frequency information for TN cells of the areas. As another example, the configuration information may include a list of SMTCs or a list of SMTC offsets between a serving cell of the UE 120 and one or more targets or neighbor cells. As another example, the configuration information may indicate a reference location and/or a threshold for a location-based measurement trigger.

As shown by reference number 610, the UE 120 may collect logged MDT information. For example, the UE 120 may collect logged MDT information in association with an OOC state for at least one of an NTN or a TN. In some aspects, the logged MDT information may identify the OOC state. Additionally, or alternatively, the OOC state may be a trigger for initiating collection of, or reporting, the logged MDT information. In some aspects, the logged MDT information may include, for example, neighboring cell measurements, Bluetooth measurements, wireless local area network measurements, sensor measurements, or the like. A UE 120 that is out of coverage may be referred to as being OOC.

In some aspects, a first state of the OOC state may indicate that the UE 120 is in coverage of a TN and OOC of an NTN. In some aspects, a second state of the OOC state may indicate that the UE 120 is in coverage of an NTN and OOC of a TN. In some aspects, a third state of the OOC state may indicate that the UE 120 is in coverage of a TN and an NTN. In some aspects, a fourth state of the OOC state may indicate that the UE 120 is OOC of an NTN and a TN. In some aspects, the OOC state may be a trigger for starting logged MDT collection. For example, collecting the logged MDT information may include collecting the logged MDT information in response to an event corresponding to the OOC state. The event may correspond to, for example, the second state, the third state, or the fourth state.

As mentioned, in some aspects, the UE 120 may log the OOC state in association with or as a part of the logged MDT information. For example, the UE 120 may store, in a logged MDT report in a logging interval (e.g., each logging interval), an indication of an OOC state. In some aspects, the indication may indicate the first state (e.g., an NTN OOC indication). In some aspects, the indication may indicate the second state (e.g., a TN OOC indication). In some aspects, the indication may indicate the fourth state (e.g., an OOC indication).

In some aspects, the configuration information mentioned above may indicate a predicted coverage outage, via NTN payload assistance information. For example, as an NTN payload (e.g., satellite) moves on a specified orbit, the NTN payload's beam(s) coverage area may move and cover different portions of a geographical area due to the orbital movement of the NTN payload. As a consequence, a UE 120 located in the geographical area may experience a situation of discontinuous coverage, due to, e.g., a sparse satellite constellation deployment. To enable the UE, in an RRC idle mode, to save power during periods of no coverage, the network node 110 may provide NTN payload assistance information (e.g., ephemeris parameters, the start-time of upcoming NTN payload coverage) in a SIB (e.g., SIB32) to enable the UE to predict when coverage will be provided by upcoming NTN payloads. When the UE is in a coverage outage, the UE 120 may be permitted to skip access-stratum functions.

In some aspects, the logged MDT information or the logged MDT report may indicate whether a coverage outage was indicated as a predicted coverage outage. For example, while collecting logged MDT information, the UE 120 may indicate whether a coverage hole was a “true” (e.g., unpredicted, unanticipated) coverage hole, or was a predicted coverage hole indicated by NTN payload assistance information. Additionally, or alternatively, the logged MDT information may indicate a difference between a predicted coverage outage and an observed coverage outage. For example, the UE 120 may report a mismatch between real coverage (e.g., observed coverage) and predicted coverage as indicated by the NTN payload assistance information. In some aspects, the difference may be reported as a difference between an expected start-time of an upcoming NTN payload coverage indicated by the NTN payload assistance information, and an actual start time of the NTN payload coverage. Additionally, or alternatively, if a next start time or a next satellite start time is available in the NTN payload assistance information, the UE 120 may use the start time to report a mismatch between a broadcast cell's stop time and the start time.

In some aspects, the UE 120 may collect the logged MDT information after a logged measurement timer has expired. For example, the logged measurement timer may include a T330 timer. In this example, the UE 120 may be allowed to store the logged MDT information (e.g., may store the logged MDT information) until a start of a next NTN connection, such as a next satellite connection. In some aspects, a duration of the logged measurement timer is associated with the NTN. For example, the duration may correspond to NTNs, and may differ from a duration for TNs. In some examples, the duration for TNs may be up to 120 minutes, and the duration for NTNs may be longer than 120 minutes. Similarly, in some aspects, the UE 120 may collect logged MDT information in accordance with a logging interval that indicates how often to collect the logged MDT information. A duration of the interval may be associated with the NTN. For example, a duration of the interval may be longer than a duration of a logging interval for TNs (e.g., longer than 61.44 seconds). In some aspects, the UE 120 may store the logged MDT information for a length of time. For example, the UE 120 may store the logged MDT information for more than 48 hours or until a start of a next satellite connection, which may provide storage of logged MDT information during extended periods of outage.

As mentioned, in some aspects, an NTN cell (e.g., network node 110) may broadcast TN cell coverage information as a list of areas and associated frequency information in a SIB. The UE 120 may not be required to perform frequency measurement if the UE 120 is outside of the listed TN area. However, in some cases, the area coverage information may not be accurate. Thus, in some aspects, the logged MDT information or the logged MDT report may indicate whether a measurement of the logged MDT information was performed outside of an indicated TN coverage area. For example, while collecting logged MDT information for a TN frequency, a UE 120 may indicate whether the measurement of the logged MDT information was performed outside the indicated TN coverage area (such as by using an area identifier). Additionally, or alternatively, the UE 120 may indicate a distance error (e.g., difference) between an observed (e.g., true) coverage area of the TN and a coverage area of the TN as indicated by the TN cell coverage information. In some aspects, while collecting logged MDT information for a TN frequency, the UE 120 may indicate whether the UE 120 detected other TN frequencies that were not listed or associated with the given TN coverage area. For example, the logged MDT information or the logged MDT report further may indicate a detected frequency that is not indicated as associated with the indicated TN coverage area. Additionally, or alternatively, the UE 120 may indicate a list of new frequencies that are detected in the TN coverage area. In some aspects, the UE 120 may not be required to perform measurements on any other frequencies than the frequencies listed/associated with the TN coverage area. In some aspects, the logged MDT information or the logged MDT report includes an indicator of whether one or more neighboring frequencies, cells, or beams for which the measurement is collected belong to the TN or the NTN.

As mentioned, in some aspects, the configuration information may include a plurality of SMTCs or a plurality of SMTC offsets. For example, for IDLE mode measurements, a serving cell (e.g., network node 110) may provide an SMTC or multiple SMTCs of one or more neighbor cells. It may be up to the UE 120 regarding which SMTC to use for the neighbor cell measurements, since over time, the SMTC offset may change due to moving satellites. In some aspects, the UE 120 may collect the logged MDT information using an SMTC offset of the plurality of SMTC offsets, and the logged MDT report or the logged MDT information may indicate the SMTC offset. Additionally, or alternatively, the logged MDT report or the logged MDT information may indicate an SMTC offset that was not used to collect the logged MDT information or that was useless. Additionally, or alternatively, the logged MDT report or the logged MDT information may indicate an offset between an SMTC of a camped (e.g., serving) cell and an SMTC of a neighbor cell. For example, while collecting logged MDT information, the UE 120 may indicate the SMTC offset between the camped cell and the neighbor cell or a propagation delay difference between the camped cell and the neighbor cell. In some aspects, the SMTC offset may correspond to a particular measurement of the logged MDT information. For example, the UE 120 may indicate (in the logged MDT information) instances of different SMTC offsets used to perform the neighbor cell measurements at different instances of measurement occasions. Thus, the logged MDT information may indicate multiple offsets corresponding to multiple measurements of the logged MDT information.

As mentioned, location-based measurement triggering may be supported in NTN. The network node 110 may broadcast a reference location and a threshold distance. If the UE 120 is separated from the reference location by at least the threshold distance (indicating that the UE 120 is at a cell edge), the UE 120 may perform measurement regardless of an RSRP of the serving cell. However, in some situations, there may be errors in coverage, and the distance threshold may not accurately represent the cell edge. In some aspects, the UE 120 may indicate a length of time for which the UE 120 was able to stay in a current serving cell of the UE 120 after location-based measurement was triggered and performed. For example, a longer length of time may mean that when measurement was triggered, the neighbor cells were not established yet or had a weak signal, indicating that a current serving cell service duration was long enough to facilitate communication of the UE 120. Thus, the UE 120 can help the network node 110 to set the threshold distance to represent the cell edge boundary more accurately.

In some aspects, the UE 120 may identify a trigger for location-based measurement (such as based on the UE 120's serving cell's reference location). In this case, in some aspects, the UE 120 may indicate a distance between the UE 120 and a neighbor cell's reference location (if provided). Additionally, or alternatively, the UE 120 may indicate a distance between the UE 120 and a satellite of the neighbor cell (if the reference location is not available).

As shown by reference number 615, the UE 120 may transmit, and the network node 110 may receive, a logged MDT report. The logged MDT report may indicate the OOC state and the logged MDT information collected at reference number 610.

As indicated above, FIG. 6 is provided as an example. Other examples may differ from what is described with respect to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with MDT or successful mobility reporting.

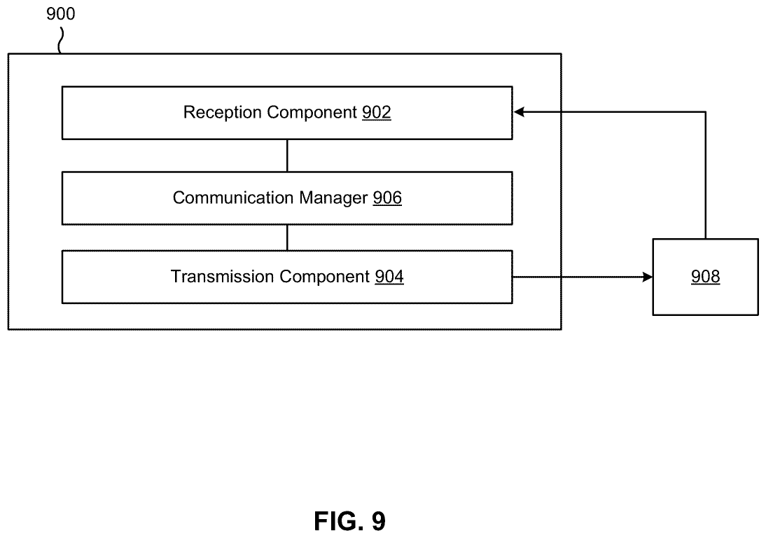

As shown in FIG. 7, in some aspects, process 700 may include performing a mobility operation within or to an NTN (block 710). For example, the UE (e.g., using communication manager 906, depicted in FIG. 9) may perform a mobility operation in or to an NTN, as described above in connection with reference number 510 of FIG. 5.

As further shown in FIG. 7, in some aspects, process 700 may include transmitting a report indicating a success or failure of the mobility operation (block 720). For example, the UE (e.g., using transmission component 904 and/or communication manager 906, depicted in FIG. 9, and/or via a transceiver) may transmit a report indicating a success or failure of the mobility operation. In some aspects, the UE transmits the report if a timing difference of the mobility operation satisfies a threshold associated with at least one of the NTN or the mobility operation, as described above in connection with reference number 515 of FIG. 5. Additionally, or alternatively, the UE may transmit the report regardless of whether the timing differences satisfies the threshold associated with at least one of the NTN or the mobility operation or does not satisfy the threshold associated with at least one of the NTN or the mobility operation. For example, the report may indicate whether or not the timing difference satisfies the threshold associated with at least one of the NTN or the mobility operation. As another example, the report may indicate the timing difference.

Process 700 may include additional aspects, such as any single aspect or any combination of aspects described below and/or in connection with one or more other processes described elsewhere herein.

In a first aspect, the mobility operation comprises a handover.

In a second aspect, alone or in combination with the first aspect, the mobility operation comprises a primary secondary cell change or addition.

In a third aspect, alone or in combination with one or more of the first and second aspects, the timing difference comprises a propagation delay difference.

In a fourth aspect, alone or in combination with one or more of the first through third aspects, the timing difference comprises a timing adjustment drift.

In a fifth aspect, alone or in combination with one or more of the first through fourth aspects, the timing difference comprises an offset of a synchronization signal block measurement timing configuration.

In a sixth aspect, alone or in combination with one or more of the first through fifth aspects, process 700 includes receiving configuration information indicating the threshold associated with the NTN.

In a seventh aspect, alone or in combination with one or more of the first through sixth aspects, transmitting the report further comprises transmitting the report in response to at least one of the UE failing to synchronize to a new satellite, the UE failing to select a beam for which a configuration of the report was provided, the UE failing to select a beam for which the report is enabled, or the UE falling back to a RACH-based handover from a configured RACH-less handover.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with MDT or successful mobility reporting.

As shown in FIG. 8, in some aspects, process 800 may include collecting, in association with an OOC state for at least one of a TN or an NTN, logged MDT information (block 810). For example, the UE (e.g., using communication manager 906, depicted in FIG. 9) may collect, in association with an OOC state for at least one of a TN or an NTN, logged MDT information, as described above in connection with reference number 610 of FIG. 6.

As further shown in FIG. 8, in some aspects, process 800 may include transmitting a logged MDT report indicating the OOC state and the logged MDT information (block 820). For example, the UE (e.g., using transmission component 904 and/or communication manager 906, depicted in FIG. 9, and/or via a transceiver) may transmit a logged MDT report indicating the OOC state and the logged MDT information, as described above in connection with reference number 610 of FIG. 6.

Process 800 may include additional aspects, such as any single aspect or any combination of aspects described below and/or in connection with one or more other processes described elsewhere herein.

In a first aspect, the OOC state indicates one of the TN being in coverage and the NTN being OOC, the NTN being in coverage and the TN being OOC, or both the TN and the NTN being OOC.

In a second aspect, alone or in combination with the first aspect, collecting the logged MDT information further comprises collecting the logged MDT information in response to an event corresponding to the OOC state.

In a third aspect, alone or in combination with one or more of the first and second aspects, collecting the logged MDT information further comprises logging the OOC state in association with the logged MDT information.

In a fourth aspect, alone or in combination with one or more of the first through third aspects, the logged MDT information or the logged MDT report indicates whether a coverage outage was indicated as a predicted coverage outage.

In a fifth aspect, alone or in combination with one or more of the first through fourth aspects, the logged MDT information indicates a difference between a predicted coverage outage and an observed coverage outage.

In a sixth aspect, alone or in combination with one or more of the first through fifth aspects, collecting the logged MDT information further comprises collecting the logged MDT information after a logged measurement timer has expired.

In a seventh aspect, alone or in combination with one or more of the first through sixth aspects, collecting the logged MDT information further comprises storing the logged MDT information until a start of a next NTN connection.

In an eighth aspect, alone or in combination with one or more of the first through seventh aspects, a duration of the logged measurement timer is associated with the NTN.

In a ninth aspect, alone or in combination with one or more of the first through eighth aspects, collecting the logged MDT information further comprises collecting the logged MDT information in accordance with an interval, wherein a duration of the interval is associated with the NTN.

In a tenth aspect, alone or in combination with one or more of the first through ninth aspects, the logged MDT information or the logged MDT report indicates whether a measurement of the logged MDT information was performed outside of an indicated TN coverage area.

In an eleventh aspect, alone or in combination with one or more of the first through tenth aspects, the logged MDT information or the logged MDT report further indicates a detected frequency that is not indicated as associated with the indicated TN coverage area.

In a twelfth aspect, alone or in combination with one or more of the first through eleventh aspects, process 800 includes collecting the logged MDT information using an SMTC offset of the plurality of SMTC offsets, wherein the logged MDT report or the logged MDT information indicates the SMTC offset.

In a thirteenth aspect, alone or in combination with one or more of the first through twelfth aspects, the logged MDT report or the logged MDT information indicates a synchronization signal block (SSB) measurement timing configuration (SMTC) offset that was not used to collect the logged MDT information.

In a fourteenth aspect, alone or in combination with one or more of the first through thirteenth aspects, the logged MDT report or the logged MDT information indicates an offset between a synchronization signal block measurement timing configuration of a camped cell and a synchronization signal block measurement timing configuration of a neighbor cell.

In a fifteenth aspect, alone or in combination with one or more of the first through fourteenth aspects, the offset corresponds to a particular measurement of the logged MDT information.

In a sixteenth aspect, alone or in combination with one or more of the first through fifteenth aspects, the logged MDT information indicates a second offset corresponding to another measurement of the logged MDT information.

In a seventeenth aspect, alone or in combination with one or more of the first through sixteenth aspects, the logged MDT report or the logged MDT information indicates an offset between a propagation delay of a camped cell and a propagation delay of a neighbor cell.

In an eighteenth aspect, alone or in combination with one or more of the first through seventeenth aspects, the logged MDT report or the logged MDT information indicates a length of time for which the UE was on a given serving cell after location-based measurement is triggered.

In a nineteenth aspect, alone or in combination with one or more of the first through eighteenth aspects, process 800 includes identifying a trigger for location-based measurement, wherein the logged MDT information or the logged MDT report indicates a distance between the UE and a neighbor cell reference location indicated by the trigger.

In a twentieth aspect, alone or in combination with one or more of the first through nineteenth aspects, process 800 includes identifying a trigger for location-based measurement, wherein the logged MDT information or the logged MDT report indicates a distance between the UE and a satellite of a neighbor cell.

In a twenty-first aspect, alone or in combination with one or more of the first through twentieth aspects, collecting the logged MDT information further comprises collecting the logged MDT information in response to at least one of the UE failing to synchronize to a new satellite, the UE failing to select a beam for which a configuration of the report was provided, the UE failing to select a beam for which the logged MDT report is enabled, or the UE falling back to a random-access-channel (RACH)-based handover from a configured RACH-less handover.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may perform a mobility operation in or to an NTN. The transmission component 904 may transmit a report indicating a success of the mobility operation, wherein the report is associated with a timing difference of the mobility operation satisfying a threshold associated with at least one of the NTN or the mobility operation.

The reception component 902 may receive configuration information indicating the threshold associated with the NTN.

The communication manager 906 may collect, in association with an OOC state for at least one of a TN or an NTN, logged MDT information. The transmission component 904 may transmit a logged MDT report indicating the OOC state and the logged MDT information. The communication manager 906 may collect the logged MDT information using an SMTC offset of the plurality of SMTC offsets, wherein the logged MDT report or the logged MDT information indicates the SMTC offset. The communication manager 906 may identify a trigger for location-based measurement, wherein the logged MDT information or the logged MDT report indicates a distance between the UE and a neighbor cell reference location indicated by the trigger. The communication manager 906 may identify a trigger for location-based measurement, wherein the logged MDT information or the logged MDT report indicates a distance between the UE and a satellite of a neighbor cell.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: performing a mobility operation within or to a non-terrestrial network (NTN); and transmitting, via the transceiver, a report indicating a success or failure of the mobility operation if a timing difference of the mobility operation satisfies a threshold associated with at least one of the NTN or the mobility operation, or transmitting, via the transceiver, the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

Aspect 2: The method of Aspect 1, wherein the mobility operation comprises a handover.

Aspect 3: The method of any of Aspects 1-2, wherein the mobility operation comprises a primary secondary cell change or addition.

Aspect 4: The method of any of Aspects 1-3, wherein the timing difference comprises a propagation delay difference.

Aspect 5: The method of any of Aspects 1-4, wherein the timing difference comprises a timing adjustment drift.

Aspect 6: The method of any of Aspects 1-5, wherein the timing difference comprises an offset of a synchronization signal block measurement timing configuration.

Aspect 7: The method of any of Aspects 1-6, further comprising receiving configuration information indicating the threshold.

Aspect 8: The method of any of Aspects 1-7, wherein transmitting the report further comprises transmitting the report in response to at least one of: the UE failing to synchronize to a new satellite, the UE failing to select a beam for which a configuration of the report was provided, the UE failing to select a beam for which the report is enabled, or the UE falling back to a random-access-channel (RACH)-based handover from a configured RACH-less handover.

Aspect 9: A method of wireless communication performed by a user equipment (UE), comprising: collecting, in association with an out-of-coverage (OOC) state for at least one of a terrestrial network (TN) or a non-terrestrial network (NTN), logged minimization of drive test (MDT) information; and transmitting a logged MDT report indicating the OOC state and the logged MDT information.

Aspect 10: The method of Aspect 9, wherein the OOC state indicates one of: the TN being in coverage and the NTN being OOC, the NTN being in coverage and the TN being OOC, or both the TN and the NTN being OOC.

Aspect 11: The method of any of Aspects 9-10, wherein collecting the logged MDT information further comprises collecting the logged MDT information in response to an event corresponding to the OOC state.

Aspect 12: The method of any of Aspects 9-11, wherein collecting the logged MDT information further comprises logging the OOC state in association with the logged MDT information.

Aspect 13: The method of any of Aspects 9-12, wherein the logged MDT information or the logged MDT report indicates whether a coverage outage was indicated as a predicted coverage outage.

Aspect 14: The method of any of Aspects 9-13, wherein the logged MDT information indicates a difference between a predicted coverage outage and an observed coverage outage.

Aspect 15: The method of any of Aspects 9-14, wherein collecting the logged MDT information further comprises collecting the logged MDT information after a logged measurement timer has expired.

Aspect 16: The method of Aspect 15, wherein collecting the logged MDT information further comprises storing the logged MDT information until a start of a next NTN connection.

Aspect 17: The method of Aspect 15, wherein a duration of the logged measurement timer is associated with the NTN.

Aspect 18: The method of Aspect 17, where collecting the logged MDT information further comprises collecting the logged MDT information in accordance with an interval, wherein a duration of the interval is associated with the NTN.

Aspect 19: The method of any of Aspects 9-18, wherein the logged MDT information or the logged MDT report indicates whether a measurement of the logged MDT information was performed inside or outside of an indicated TN coverage area or includes an indicator of whether one or more neighboring frequencies, cells, or beams for which the measurement is collected belong to the TN or the NTN.

Aspect 20: The method of Aspect 19, wherein the logged MDT information or the logged MDT report further indicates a detected frequency that is not indicated as associated with the indicated TN coverage area.

Aspect 21: The method of any of Aspects 9-20, further comprising receiving a configuration of a plurality of synchronization signal block (SSB) measurement timing configuration (SMTC) offsets, wherein collecting the logged MDT information further comprises collecting the logged MDT information using an SMTC offset of the plurality of SMTC offsets, wherein the logged MDT report or the logged MDT information indicates the SMTC offset.

Aspect 22: The method of any of Aspects 9-21, wherein the logged MDT report or the logged MDT information indicates a synchronization signal block (SSB) measurement timing configuration (SMTC) offset that was not used to collect the logged MDT information.

Aspect 23: The method of any of Aspects 9-22, wherein the logged MDT report or the logged MDT information indicates an offset between a synchronization signal block measurement timing configuration of a camped cell and a synchronization signal block measurement timing configuration of a neighbor cell.

Aspect 24: The method of Aspect 23, wherein the offset corresponds to a particular measurement of the logged MDT information.

Aspect 25: The method of Aspect 24, wherein the logged MDT information indicates a second offset corresponding to another measurement of the logged MDT information.

Aspect 26: The method of any of Aspects 9-25, wherein the logged MDT report or the logged MDT information indicates an offset between a propagation delay of a camped cell and a propagation delay of a neighbor cell.

Aspect 27: The method of any of Aspects 9-26, wherein the logged MDT report or the logged MDT information indicates a length of time for which the UE was on a given serving cell after location-based measurement is triggered.

Aspect 28: The method of any of Aspects 9-27, further comprising identifying a trigger for location-based measurement, wherein the logged MDT information or the logged MDT report indicates a distance between the UE and a neighbor cell reference location indicated by the trigger.

Aspect 29: The method of any of Aspects 9-28, further comprising identifying a trigger for location-based measurement, wherein the logged MDT information or the logged MDT report indicates a distance between the UE and a satellite of a neighbor cell.

Aspect 30: The method of any of Aspects 9-29, wherein collecting the logged MDT information further comprises collecting the logged MDT information in response to at least one of: the UE failing to synchronize to a new satellite, the UE failing to select a beam for which a configuration of the report was provided, the UE failing to select a beam for which the logged MDT report is enabled, or the UE falling back to a random-access-channel (RACH)-based handover from a configured RACH-less handover.

Aspect 31: An apparatus for wireless communication at a device, the apparatus comprising one or more processors; a transceiver; one or more memories coupled with the one or more processors and the transceiver; and instructions stored in the one or more memories and executable by the one or more processors to cause the apparatus to perform the method of one or more of Aspects 1-30.

Aspect 32: An apparatus for wireless communication at a device, the apparatus comprising one or more memories, a transceiver, and one or more processors coupled to the one or more memories and the transceiver, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories;
a transceiver; and
one or more processors, coupled to the one or more memories and the transceiver, configured to cause the UE to:
perform a mobility operation within or to a non-terrestrial network (NTN); and
transmit, via the transceiver, a report indicating a success or failure of the mobility operation if a timing difference of the mobility operation satisfies a threshold associated with at least one of the NTN or the mobility operation, or
transmit, via the transceiver, the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

2. The apparatus of claim 1, wherein the mobility operation comprises a handover.

3. The apparatus of claim 1, wherein the mobility operation comprises a primary secondary cell change or addition.

4. The apparatus of claim 1, wherein the timing difference comprises a propagation delay difference.

5. The apparatus of claim 1, wherein the timing difference comprises a timing adjustment drift.

6. The apparatus of claim 1, wherein the timing difference comprises an offset of a synchronization signal block measurement timing configuration.

7. The apparatus of claim 1, wherein the one or more processors are further configured to cause the UE to receive configuration information indicating the threshold.

8. The apparatus of claim 1, wherein the one or more processors, to cause the UE to transmit the report, are configured to cause the UE to transmit the report further in response to at least one of:
the UE failing to synchronize to a new satellite,
the UE failing to select a beam for which a configuration of the report was provided,
the UE failing to select a beam for which the report is enabled, or
the UE falling back to a random-access-channel (RACH)-based handover from a configured RACH-less handover.

9. An apparatus for wireless communication at a user equipment (UE), comprising:
one or more memories;
a transceiver; and
one or more processors, coupled to the one or more memories and the transceiver, configured to cause the UE to:
collect, in association with an out-of-coverage (OOC) state for at least one of a terrestrial network (TN) or a non-terrestrial network (NTN), logged minimization of drive test (MDT) information; and
transmit, via the transceiver, a logged MDT report indicating the OOC state and the logged MDT information.

10. The apparatus of claim 9, wherein the OOC state indicates one of:
the TN being in coverage and the NTN being OOC,
the NTN being in coverage and the TN being OOC, or
both the TN and the NTN being OOC.

11. The apparatus of claim 9, wherein the one or more processors, to cause the UE to collect the logged MDT information, are configured to cause the UE to collect the logged MDT information in response to an event corresponding to the OOC state.

12. The apparatus of claim 9, wherein the one or more processors, to cause the UE to collect the logged MDT information, are configured to cause the UE to log the OOC state in association with the logged MDT information.

13. The apparatus of claim 9, wherein the logged MDT information or the logged MDT report indicates whether a coverage outage was indicated as a predicted coverage outage.

14. The apparatus of claim 9, wherein the logged MDT information indicates a difference between a predicted coverage outage and an observed coverage outage.

15. The apparatus of claim 9, wherein the one or more processors, to cause the UE to collect the logged MDT information, are configured to cause the UE to collect the logged MDT information after a logged measurement timer has expired.

16. The apparatus of claim 15, wherein the one or more processors, to cause the UE to collect the logged MDT information, are configured to cause the UE to store the logged MDT information until a start of a next NTN connection.

17. The apparatus of claim 15, wherein a duration of the logged measurement timer is associated with the NTN.

18. The apparatus of claim 17, wherein the one or more processors, to cause the UE to collect the logged MDT information, are configured to cause the UE to collect the logged MDT information in accordance with an interval, wherein a duration of the interval is associated with the NTN.

19. The apparatus of claim 9, wherein the logged MDT information or the logged MDT report indicates whether a measurement of the logged MDT information was performed inside or outside of an indicated TN coverage area or includes an indicator of whether one or more neighboring frequencies, cells, or beams for which the measurement is collected belong to the TN or the NTN.

20. The apparatus of claim 19, wherein the logged MDT information or the logged MDT report further indicates a detected frequency that is not indicated as associated with the indicated TN coverage area.

21. The apparatus of claim 9, wherein the one or more processors are further configured to cause the UE to receive, via the transceiver, a configuration of a plurality of synchronization signal block (SSB) measurement timing configuration (SMTC) offsets, wherein the one or more processors, to cause the UE to collect the logged MDT information, are configured to cause the UE to collect the logged MDT information using an SMTC offset of the plurality of SMTC offsets,
wherein the logged MDT report or the logged MDT information indicates the SMTC offset.

22. The apparatus of claim 9, wherein the logged MDT report or the logged MDT information indicates a synchronization signal block (SSB) measurement timing configuration (SMTC) offset that was not used to collect the logged MDT information.

23. The apparatus of claim 9, wherein the logged MDT report or the logged MDT information indicates an offset between a synchronization signal block measurement timing configuration of a camped cell and a synchronization signal block measurement timing configuration of a neighbor cell.

24. The apparatus of claim 23, wherein the offset corresponds to a particular measurement of the logged MDT information.

25. The apparatus of claim 24, wherein the logged MDT information indicates a second offset corresponding to another measurement of the logged MDT information.

26. The apparatus of claim 9, wherein the logged MDT report or the logged MDT information indicates an offset between a propagation delay of a camped cell and a propagation delay of a neighbor cell.

27. The apparatus of claim 9, wherein the logged MDT report or the logged MDT information indicates a length of time for which the UE was on a given serving cell after location-based measurement is triggered.

28. The apparatus of claim 9, wherein the one or more processors are further configured to cause the UE to identify a trigger for location-based measurement, wherein the logged MDT information or the logged MDT report indicates a distance between the UE and a neighbor cell reference location indicated by the trigger.

29. A method of wireless communication performed by a user equipment (UE), comprising:
performing a mobility operation within or to a non-terrestrial network (NTN); and
transmitting a report indicating a success or failure of the mobility operation if a timing difference of the mobility operation satisfies a threshold associated with at least one of the NTN or the mobility operation, or
transmitting the report indicating the success or failure of the mobility operation regardless of whether the timing difference satisfies the threshold associated with at least one of the NTN or the mobility operation or does not satisfy the threshold associated with at least one of the NTN or the mobility operation, wherein the report indicates whether the timing difference satisfies the threshold associated with at least one of the NTN or the mobility operation or does not satisfy the threshold associated with at least one of the NTN or the mobility operation.

30. A method of wireless communication performed by a user equipment (UE), comprising:
collecting, in association with an out-of-coverage (OOC) state for at least one of a terrestrial network (TN) or a non-terrestrial network (NTN), logged minimization of drive test (MDT) information; and
transmitting a logged MDT report indicating the OOC state and the logged MDT information.
